(19) United States
(12) Patent Application Publication
(10) Pub. No.: US 2002/0137842 A1
(43) Pub. Date: Sep. 26, 2002

(54) Curable fluoropolyether base rubber compositions

(76) Inventors: Shinichi Sato, Gunma-ken (JP); Noriyuki Koike, Gunma-ken (JP)

Correspondence Address: BIRCH STEWART KOLASCH & BIRCH, PO BOX 747, FALLS CHURCH, VA, 22040-0747, US

(21) Appl. No.: 10/020,999

(22) Filed: Dec. 19, 2001

(30) Foreign Application Priority Data
Dec. 22, 2000 (JP) 2000-390456

(51) Int. Cl. C08F 8/00

(52) U.S. Cl. 525/100

(57) ABSTRACT

A curable fluoropolyether base rubber composition is provided comprising (A) a linear fluoropolyether compound containing at least two alkenyl groups and having a perfluoropolyether structure in its backbone, (B) an organosilicon compound having at least two SiH groups, all the silicon atom-bound hydrogen atoms forming H—Si(R)₂OSi structures wherein R is independently a monovalent C1-6 hydrocarbon group, (C) an organosilicon compound having at least two SiH groups, all the silicon atom-bound hydrogen atoms forming H—SiR(OSi)₂ structures wherein R is as defined above, (D) a hydrosilylation catalyst, and (E) an acetylenic hydrosilylation inhibitor. The composition cures at an adjustable curing rate into products having solvent resistance, chemical resistance, parting property, water repellency and acid resistance owing to a high fluorine content.

This invention relates to a curable fluoropolyether base rubber composition which cures into products having water repellency, oil repellency, heat resistance, solvent resistance, chemical resistance, weather resistance and parting property as well as acid resistance.

### BACKGROUND OF THE INVENTION

Japanese Patent No. 2,990,646 discloses a composition comprising a linear fluoropolyether compound containing at least two alkenyl groups per molecule and having a perfluoroalkyl ether structure in its backbone, an organosilicon compound having at least two H—SiOSi structures per molecule, and a hydrosilylation catalyst. This composition cures into products having a good profile of heat resistance, chemical resistance, solvent resistance, parting property, water repellency, oil repellency, and weather resistance.

Such fluoropolyether rubber compositions are often used in liquid injection molding systems (LIMS). During the process, the moldability of the composition largely depends on the curing rate. In the prior art, the curing rate is adjusted by changing the type and amount of the hydrosilylation catalyst and a hydrosilylation inhibitor added for controlling hydrosilylation reaction. This approach is capable of changing the curing rate, but over a limited range.

### SUMMARY OF THE INVENTION

An object of the invention is to provide a curable fluoropolyether base rubber composition which allows the curing rate, which is a very important factor to enable liquid injection molding, to be adjusted over a wide range and which cures into products having water repellency, oil repellency, heat resistance, solvent resistance, chemical resistance, weather resistance and parting property.

The invention provides a curable fluoropolyether base rubber composition comprising (A) a linear fluoropolyether compound containing at least two alkenyl groups in a molecule and having a perfluoropolyether structure in its backbone, (B) an organosilicon compound having at least two hydrogen atoms each bound to a silicon atom in a molecule, all the silicon atom-bound hydrogen atoms forming H—Si(R)₂OSi structures wherein R is independently a monovalent hydrocarbon group having 1 to 6 carbon atoms, (C) an organosilicon compound having at least two hydrogen atoms each bound to a silicon atom in a molecule, all the silicon atom-bound hydrogen atoms forming H—SiR(OSi)₂ structures wherein R is a monovalent hydrocarbon group having 1 to 6 carbon atoms, (D) a hydrosilylation catalyst, and (E) an acetylenic hydrosilylation inhibitor. This curable fluoropolyether rubber composition cures at a rate which can be adjusted over a wide range, into products having water repellency, oil repellency, heat resistance, solvent resistance, chemical resistance, weather resistance and parting property as well as acid resistance.

### DESCRIPTION OF THE PREFERRED EMBODIMENTS

The respective components of the curable fluoropolyether base rubber composition are described below.

(A) Linear Fluoropolyether Compound

The linear fluoropolyether compound used herein as a base polymer in the composition is one containing at least two alkenyl groups in a molecule and having a divalent perfluoroalkyl ether structure in its backbone.

The alkenyl groups in the linear fluoropolyether compound are those having a CH₂═CH— structure at an end such as vinyl, allyl, propenyl, isopropenyl, butenyl and hexenyl, with the vinyl and allyl being especially preferred. The alkenyl groups may be attached either directly to both ends of the backbone of the linear fluoropolyether compound or to the backbone through a divalent linking group such as —CH₂—, —CH₂O— or —Y—NR′—CO—. Herein Y is —CH₂— or a group of the following structural formula:

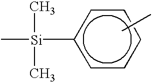

(the bond may be at o, m or p-position), and R′ is hydrogen, methyl, phenyl or allyl.

The perfluoroalkyl ether structure in the linear fluoropolyether compound includes those of the following general formula:

—(Rf—O)_{q}—

wherein Rf is a straight or branched perfluoroalkylene group of 1 to 6 carbon atoms, preferably 1 to 3 carbon atoms, and letter q is an integer of 1 to 500, preferably 2 to 400, more preferably 10 to 200.

Examples of the recurring units —(Rf—O)— are shown below.

—CF₂O—, —CF₂CF₂O—, —CF₂CF₂CF₂O—, —CF(CF₃)CF₂O—, —CF₂CF₂CF₂CF₂O—, —CF₂CF₂CF₂CF₂CF₂CF₂O—, and —C(CF₃)₂O—.

Of these, —CF₂O—, —CF₂CF₂O—, —CF₂CF₂CF₂O—, and —CF(CF₃)CF₂O— are preferred. It is understood that the perfluoroalkyl ether structure may consist of recurring units —(Rf—O)— of one type or recurring units of two or more types.

Typical of the linear fluoropolyether compound (A) are those of the following general formula (1).

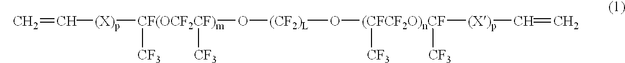

In formula (1), X is selected from among —CH₂—, —CH₂O — and —Y—NR′—CO— wherein Y is —CH₂— or a group of the following structural formula (Z):

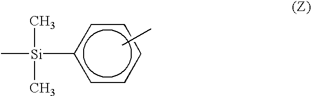

(the bond may be at o, m or p-position). X′ is selected from among —CH₂—, —OCH₂— and —CO—NR′—Y′— wherein Y′ is —CH₂— or a group of the following structural formula (Z′):

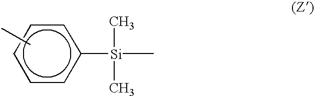

(the bond may be at o, m or p-position).

Letter p is independently equal to 0 or 1, L is an integer of 2 to 6, and m and n are integers of 0 to 200, preferably 5to 100. R′ is hydrogen, methyl, phenyl or allyl. These linear fluoropolyether compounds have a molecular weight of about 400 to 100,000 and preferably about 1,000 to 50,000.

Illustrative examples of the linear fluoropolyether compound of formula (1) are given below. In the following formulae, m and n are as defined above.

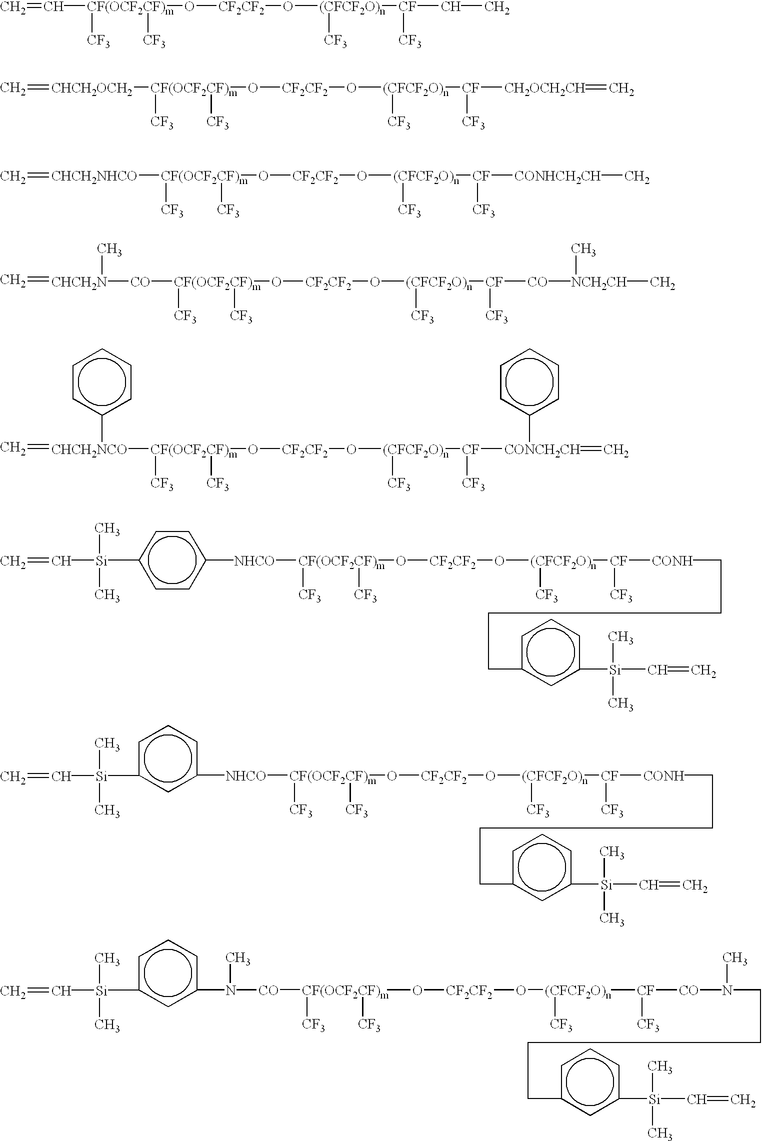

These linear fluoropolyether compounds may be used alone or in admixture of two or more.

In the practice of the invention, there may also be used as component (A) a chain extended product obtained by previously subjecting a linear fluoropolyether compound to hydrosilylation reaction with an organosilicon compound containing two SiH groups in a molecule in a conventional manner and conditions for adjusting the linear fluoropolyether compound to a desired weight average molecular weight for a particular purpose.

(B) Organosilicon Compound

The organosilicon compound (B) functions as a crosslinker and chain extender for component (A). Any organosilicon compound is useful as long as it has at least two hydrogen atoms each bound to a silicon atom in a molecule, all the silicon atom-bound hydrogen atoms forming H—Si(R)₂OSi structures wherein R is independently a monovalent hydrocarbon group having 1 to 6 carbon atoms.

Of the organosilicon compounds (B), those of the following general formula (2) are preferred.

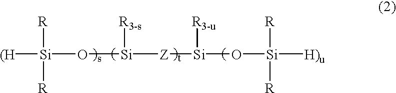

Herein R is independently a monovalent hydrocarbon group having 1 to 6 carbon atoms. Z is a divalent hydrocarbon group which may contain an ether bond or in which some or all of the hydrogen atoms may be substituted with fluorine. The subscripts s and u each are 1, 2 or 3, and t is 0 or 1, with the proviso that s=1 when t=0.

The monovalent hydrocarbon groups represented by R include alkyl groups having 1 to 6 carbon atoms such as methyl, ethyl and propyl, and aryl groups such as phenyl. The R groups may be the same or different. The divalent hydrocarbon groups represented by Z include alkylene groups having 1 to 12 carbon atoms, especially 1 to 8 carbon atoms, such as methylene, ethylene, propylene, tetramethylene and hexamethylene, arylene groups such as phenylene, and combinations of an alkylene group with an arylene group. These groups may contain an ether bond, amide bond or carbonyl bond. Some or all of the hydrogen atoms in these groups may be substituted with fluorine.

The subscripts s and u each are 1, 2 or 3, and t is 0 or 1, with the proviso that s=1 when t=0.

Illustrative, non-limiting, examples of the organosilicon compound of formula (2) are given below. Me is methyl.

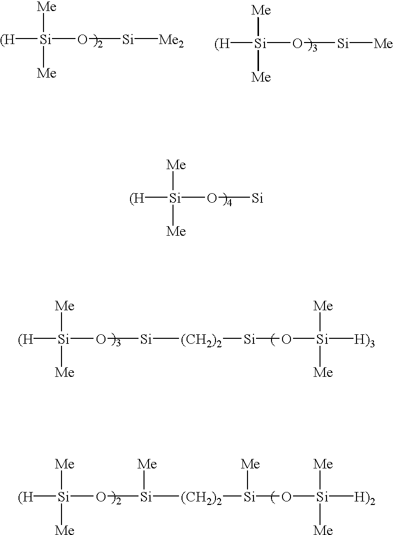

Also, organosilicon compounds having at least one monovalent perfluoroalkyl, monovalent perfluorooxyalkyl, divalent perfluoroalkylene or divalent perfluorooxyalkylene group in a molecule may be used for compatibility with and dispersibility in component (A) and uniformity after curing. It is preferred that the perfluoroalkyl or perfluoroalkylene group have 1 to 20 carbon atoms, and the perfluorooxyalkyl or perfluorooxyalkylene group have 1 to 500, especially 4 to 500 carbon atoms.

Such organosilicon compounds (B) are preferably those of the following general formulae (3) and (4).

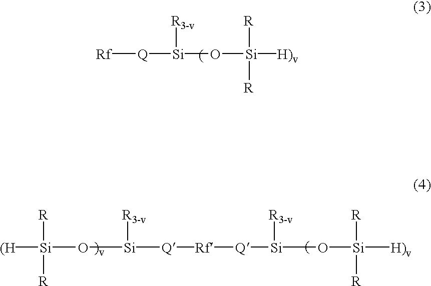

Herein R is as defined above, Q is a divalent hydrocarbon group of 1 to 12 carbon atoms which may contain an ether bond, Rf is a monovalent perfluoroalkyl or perfluorooxyalkyl group, Q′ is a divalent organic group, Rf′ is a divalent perfluoroalkylene or perfluorooxyalkylene group, and v is 1, 2 or 3.

As noted above, Q includes alkylene groups of 1 to 12 carbon atoms, especially 1 to 8 carbon atoms, such as methylene, ethylene, propylene, tetramethylene and hexamethylene and the foregoing alkylene groups which are separated by an ether bond (—O—).

The perfluoroalkyl, perfluorooxyalkyl, perfluoroalkylene and perfluorooxyalkylene groups represented by Rf and Rf′ are exemplified by the groups of the following general formulae.

monovalent perfluoroalkyl groups:

C_{g}F_{2g+1}—

g is an integer of 1 to 20, preferably 2 to 10. divalent perfluoroalkylene groups:

—C_{g}F_{2g—}

g is an integer of 1 to 20, preferably 2 to 10.

monovalent perfluorooxyalkyl groups:

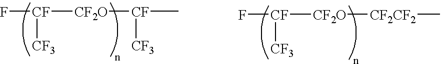

n is an integer of 1 to 5.

divalent perfluorooxyalkylene groups:

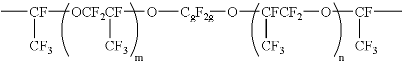

m+n is an integer of 1 to 200.

—(CF₂O)ₘ—(CF₂CF₂O)ₙ—CF₂—

m and n each are an integer of 1 to 50.

These perfluoro(oxy)alkyl and perfluoro(oxy)alkylene groups, represented by Rf and Rf′, each may be attached either directly to a silicon atom or to a silicon atom through a divalent linking group Q′. The divalent linking group is an alkylene group, arylene group or a mixture thereof, which may be further separated by an ether bond oxygen atom, amide bond, carbonyl bond or SiR₂ wherein R is as defined above. Such divalent linking groups of 2 to 12 carbon atoms are preferred. Illustrative examples thereof are given below.

—CH₂CH₂—

—CH₂CH₂CH₂—

—CH₂CH₂CH₂OCH₂—

—CH₂CH₂CH₂—NH—CO—

—CH₂CH₂CH₂—N(Ph)—CO—

—CH₂CH₂CH₂—N(CH₃)—CO—

—CH₂CH₂CH₂—O—CO—

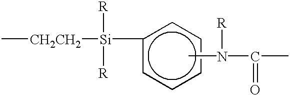

Note that Ph is phenyl and R is as defined above.

Illustrative, non-limiting, examples of the foregoing organosilicon compounds are given below. These compounds may be used alone or in admixture of any. Note that Me is methyl.

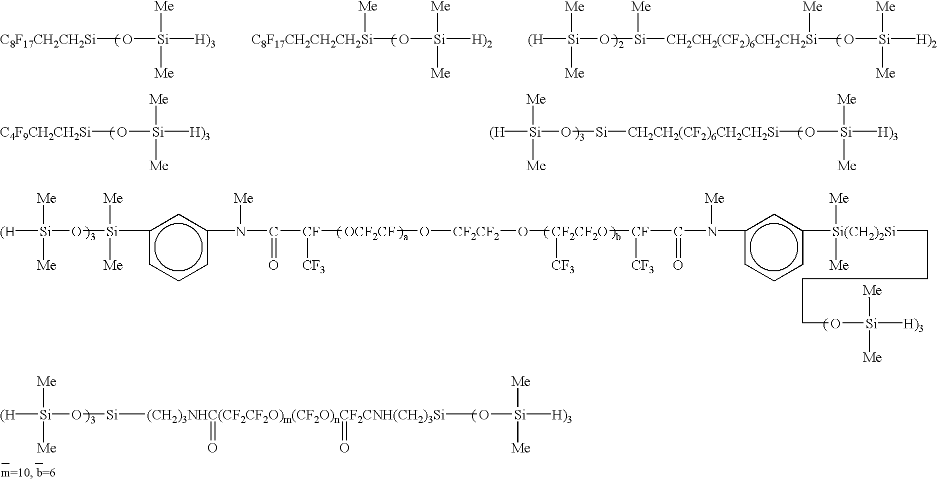

The organosilicon compound having hydrosilyl (SiH) groups (B) is preferably blended in such an amount that 0.5 to 5 mol, and more preferably 1 to 2 mol of SiH groups may be available from components (B) and (C) per mol of alkenyl groups (e.g., vinyl, allyl or cycloalkenyl) in component (A). Less amounts of SiH groups may achieve an insufficient degree of crosslinking. Excessive amounts of SiH groups may allow chain lengthening to become preferential, inviting short cure, foaming, and losses of heat resistance and compression set.

(C) Organosilicon Compound

Like component (B), the organosilicon compound (C) functions as a crosslinker and chain extender for component (A). The curing rate can be controlled by adjusting the amount of component (C) added. Any organosilicon compound is useful as long as it has at least two hydrogen atoms each bound to a silicon atom in a molecule, all the silicon atom-bound hydrogen atoms forming H—SiR(OSi)₂ structures wherein R is a monovalent hydrocarbon group having 1 to 6 carbon atoms.

Illustrative, non-limiting, examples of the organosilicon compound (C) are given below. These compounds may be used alone or in admixture of any. Note that Me is methyl.

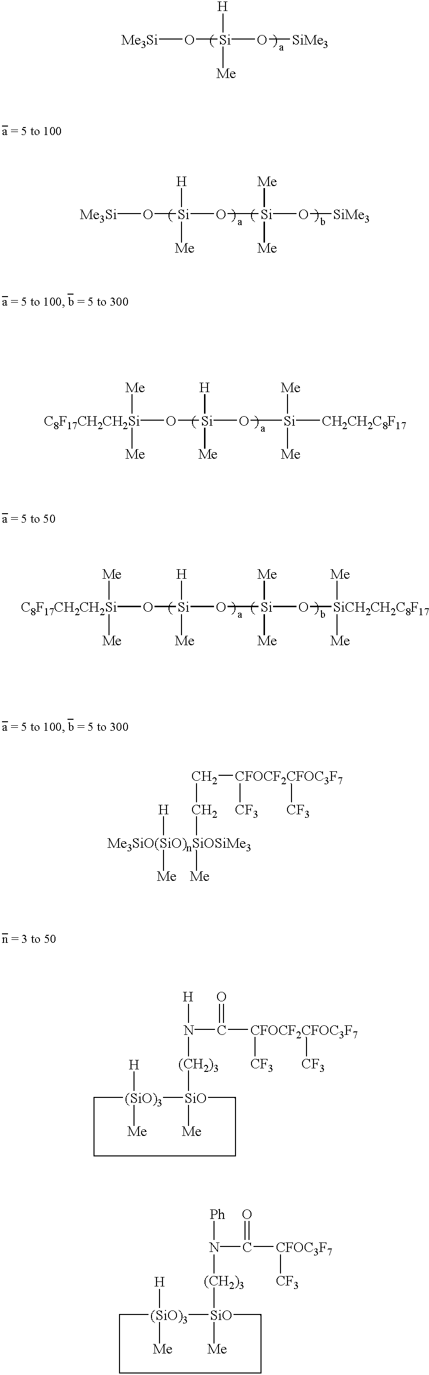

The organosilicon compound having hydrosilyl (SiH) groups (C) is preferably blended in such an amount that 0.5 to 5 mol, and more preferably 1 to 2 mol of SiH groups may be available from components (B) and (C) per mol of alkenyl groups (e.g., vinyl, allyl or cycloalkenyl) in component (A). Less amounts of SiH groups may achieve an insufficient degree of crosslinking. Excessive amounts of SiH groups may allow chain lengthening to become preferential, inviting short cure, foaming, and losses of heat resistance and compression set.

Components (B) and (C) are mixed such that the ratio of component (B)/(C) is from 99/1 to 50/50 on a SiH group molar basis.

(D) Hydrosilylation Catalyst

Component (D) in the inventive composition is a hydrosilylation catalyst for promoting addition reaction or hydrosilylation of component (A) with (B) and (C).

The hydrosilylation catalyst (D) is preferably selected from transition metals, for example, platinum group metals such as Pt, Rh and Pd, and compounds of transition metals. Most of these compounds are noble metal compounds which are expensive. Platinum and platinum compounds are thus used because they are readily available.

Exemplary platinum compounds include chloroplatinic acid, complexes of chloroplatinic acid with olefins such as ethylene, complexes of chloroplatinic acid with alcohols and vinylsiloxanes, and platinum supported on silica, alumina or carbon though are not limited thereto. Known platinum group metal compounds other than the platinum compounds include rhodium, ruthenium, iridium, and palladium compounds, for example, RhCl(PPh₃)₃, RhCl(CO)(PPh₃)₂, RhCl(C₂H₄)₂, Ru₃(CO)₁₂, IrCl(CO)(PPh₃)₂, and Pd(PPh₃)₄ wherein Ph denotes phenyl.

The amount of the catalyst used is not critical. A catalytic amount can achieve a desired curing rate. Since the catalyst is used in various forms such as supported on a carrier such as silica or alumina or diluted with a solvent, the amount of the catalyst added varies depending on the particular form or dilution ratio. From the economical aspect and to obtain satisfactory cured products, the platinum group metal compound is preferably added in an amount of about 0.1 to about 1,000 parts, more preferably about 0.1 to about 500 parts by weight calculated as the platinum group metal per million parts by weight of the entire curable composition.

(E) Acetylenic Hydrosilylation Inhibitor

The acetylenic hydrosilylation inhibitor (E) used herein is selected from those described in U.S. Pat. No. 3,445,420 and JP-B 54-3774. Illustrative examples are given below.

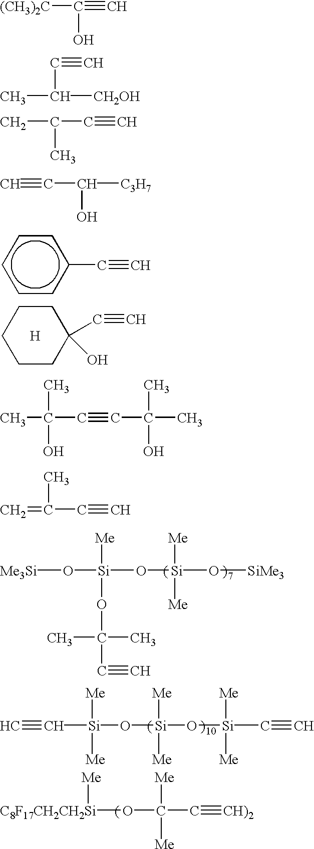

Component (E) is preferably added in an amount of 2 to 1,000 mol, especially 10 to 100 mol per mol of component (D).

Other Components

Insofar as the benefits of the invention are not impaired, various well-known additives may be added to the inventive composition in addition to the above essential components (A) to (E). For example, fillers may be added for the purposes of reducing thermal shrinkage upon curing, reducing the coefficient of thermal expansion of the cured elastomer, improving thermal stability, weather resistance, chemical resistance, flame retardance or mechanical strength, and/or lowering the gas permeability. Exemplary fillers include fumed silica, quartz flour, glass fibers, carbon, metal oxides such as iron oxide, titanium oxide and cerium oxide, and metal carbonates such as calcium carbonate and magnesium carbonate. If desired, suitable pigments, dyes and antioxidants are added.

On practical use, the inventive composition may be dissolved in a suitable fluorochemical solvent such as m-xylylene hexafluoride or fluorinate to a desired concentration, depending on a particular application or purpose.

Construction of Composition

The inventive composition may be constructed as a one-part or two-part system. In the one-part system, all the essential components (A) to (E) are combined and handled as one part. In the two-part system, for example, a portion of component (A) and components (B) and (C) are combined as one part and the remainder of component (A) and components (D) and (E) are combined as the other part. On use, these two parts are mixed together.

Preferably, the composition thus obtained has a viscosity of 50 to 2,000 Pa·s at 25° C., especially 200 to 1,000 Pa·s at 25° C. as measured according to JIS K7117. Outside the range, the composition may become difficult to mold.

Depending on the type of functional group in component (A) and the type of catalyst (D), the inventive composition is curable at room temperature. It can be cured within a brief time of several minutes to several hours by heating at a temperature of about 100 to 150° C.

The curable fluoropolyether base rubber composition of the invention can be molded in a conventional way. In particular, liquid injection molding (LIM) is possible because the curing rate can be adjusted by changing the amount of components (B) and (C) added.

The inventive compositions are useful in a variety of applications, for example, as rubber materials for automobiles and aircraft, seal materials for semiconductor manufacturing apparatus, tent film materials, sealants, molded parts, extruded parts, coatings, roll materials for copiers, moisture-proof coatings for electric apparatus, potting materials for sensors, and release paper materials.

### EXAMPLE

Examples of the invention are given below by way of illustration and not by way of limitation. The viscosity is a measurement at 25° C. All parts are by weight.

### Example 1 and Comparative Example 1

To 100 parts of a polymer of formula (5) below (viscosity 8,500 cs, average molecular weight 22,000, and vinyl content 0.009 mol/100 g) was added 40 parts of dimethylsiloxy-treated fumed silica having a specific surface area of 200 m²/g. They were mixed and heat treated. The mixture was diluted by adding 60 parts of the polymer of formula (5). The mixture was milled on a three-roll mill. To the mixture were added 0.32 part of a toluene solution of a catalyst in the form of chloroplatinic acid modified with CH₂═CHSiMe₂OSiMe₂CH═CH₂ (platinum concentration 1.0 wt %), 0.64 part of a 50% toluene solution of ethynyl cyclohexanol, 2.98 parts of a fluorinated organosilicon compound of formula (6) below, and 0, 0.16, 0.32 or 0.48 part of a fluorinated organosilicon compound of formula (7) below. They were mixed to give composition I, II, III or IV. Composition I is Comparative Example 1.

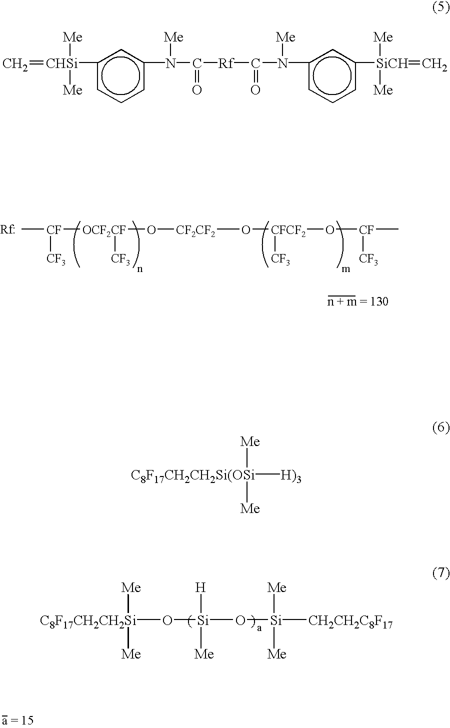

After each composition was deaerated in vacuum, it was cured by heating at 150° C. The curing rate was measured by means of a disk rheometer ASTM-100 (Toyo Seiki K.K.). The results are shown in Table 1.

TABLE 1
Curing rate

| | | t10 | t80 |
|---|---|---|---|
| | | (sec) | (sec) |
| Comparative Example 1 | Composition I | 18 | 23 |
| Example 1 | Composition II | 34 | 47 |
| | Composition III | 52 | 69 |
| | Composition IV | 63 | 82 |

t10: time taken until the torque reached 10% of the maximum torque on 150° C./6 minute curing.
t80: time taken until the torgue reached 80% of the maximum torque on 150° C./6 minute curing.

Using LIM machine HM-7 by Nissei Jushi K.K., the compositions I, II, III and IV were injection molded into O-rings. The results are shown in Table 2.

TABLE 2
LIM

| | Comparative | | | |
|---|---|---|---|---|
| | Example 1 | Example 1 | | |
| | Composition | Composition | Composition | Composition |
| | I | II | III | IV |
| LIM | poor | good | excellent | good |
| moldability | | | | |
| % pass of | 48 | 93 | 98 | 94 |
| O-rings | | | | |

As seen from Table 2, the moldability by LIM machine and percent pass of O-rings can be improved by adjusting the curing rate.

Separately, each of compositions I, II, III and IV was placed in a rectangular frame of 2 mm deep, deaerated again, press cured at 100 kgf/cm² and 150° C. for 10 minutes, and post cured at 200° C. for 4 hours. From the cured sample, a specimen was cut out and measured for physical properties according to JIS K-6251 and 6253. The results are shown in Table 3.

TABLE 3
Rubber physical properties

| | Comparative | | | |
|---|---|---|---|---|
| | Example 1 | Example 1 | | |
| | Composition | Composition | Composition | Composition |
| | I | II | III | IV |
| Hardness | 40 | 41 | 43 | 45 |
| (Durometer | | | | |
| type A) | | | | |
| Elongation, % | 540 | 480 | 430 | 390 |
| Tensile | 10.7 | 10.6 | 10.2 | 10.2 |
| strength, MPa | | | | |

The specimens were also examined for heat resistance, chemical resistance, solvent swell and low-temperature property. The results are shown in Tables 4 to 7.

The specimens of composition II were heated at 200° C. for 7 days, during which period hardness, elongation, tensile strength and heat loss were measured.

TABLE 4
Heat resistance of composition II

| | | Initial | 3 days | 7 days |
|---|---|---|---|---|
| 200° C. | Hardness | 41 | 40 (−1) | 39 (−2) |
| | (Durometer type A) | | | |
| | Elongation, % | 480 | 440 (−8) | 420 (−13) |
| | Tensile strength, MPa | 10.6 | 9.8 (−8) | 9.2 (−13) |
| | Heat loss, % | — | 0.8 | 1.5 |

The negative value in parentheses is a percent reduction from the initial value, except for a point decrease for hardness.

The specimens were degraded by dipping them in conc. hydrochloric acid, conc. sulfuric acid, conc. hydrofluoric acid and a 40% aqueous potassium hydroxide solution at 20° C. for 3 days. Hardness (Durometer type A) was measured and the surface state observed.

TABLE 5
Chemical resistance (rubber hardness change)

| | Comparative Example 1 | | Example 1 | |
|---|---|---|---|---|
| | Composition I | | Composition II | |
| Chemicals | Hardness | Surface state | Hardness | Surface state |
| (initial) | 40 | | 41 | |
| Conc. HCl | 42 (+2) | no change | 48 (+7) | no change |
| Conc. H₂SO₄ | 39 (−1) | degraded | 40 (−1) | degraded |
| Conc. HF | 39 (−1) | degraded | 30 (−11) | degraded |
| 40% KOH | 41 (+1) | no change | 41 (+0) | no change |

The value in parentheses is a point increase or decrease from the initial.

A variety of solvents were applied to the specimens of composition II, Viton GFLT (fluoroelastomer by E. I. Dupont) and FE61 (fluorosilicone rubber by Shin-Etsu Chemical Co., Ltd.). A percent volume change was reported as the solvent swell factor.

TABLE 6
Solvent swell (% volume change)

| | Composition | | |
|---|---|---|---|
| Solvent | II | Viton GFLT | FE61 |
| Gasoline | +8 | +5 | +42 |
| Methanol | +2 | +16 | +1 |
| Chloroform | +9 | +12 | +23 |
| Acetone | +5 | +148 | +177 |
| Toluene | +6 | +10 | +30 |
| IPA | +3 | +1 | +1 |
| Acetonitrile | +1 | +46 | +3 |
| MEK | +11 | +150 | +194 |
| Ethyl acetate | +10 | +150 | +172 |
| THF | +13 | +149 | +204 |
| n-hexane | +6 | +2 | +18 |
| Carbon tetrachloride | +8 | +4 | +27 |

The specimens of composition II, Viton E-60C (fluoroelastomer by E. I. Dupont) and KE951 (silicone rubber by Shin-Etsu Chemical Co., Ltd.) were examined for low-temperature property by a torsion test.

TABLE 7
Low-temperature property (torsion test)

| | Composition II | Viton E-60C | KE951 |
|---|---|---|---|
| T₂ | −35° C. | −6° C. | −41° C. |
| T₅ | −46° C. | −11° C. | −43° C. |
| T₁₀ | −53° C. | −14° C. | −44° C. |
| T₁₀₀ | −61° C. | −20° C. | −50° C. |

### Example 2

Compositions V to VII were prepared as in Example 1 except that 0.16, 0.32 or 0.48 part of a fluorinated organosilicon compound of formula (8) below was added instead of the fluorinated organosilicon compound of formula (7).

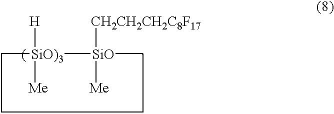

The curing rate of these compositions was determined as in Example 1. The results are shown in Table 8.

TABLE 8
Curing rate

| | | t10 | t80 |
|---|---|---|---|
| | | (sec) | (sec) |
| Comparative Example 1 | Composition I | 18 | 23 |
| Example 2 | Composition V | 25 | 36 |
| | Composition VI | 39 | 52 |
| | Composition VII | 45 | 59 |

t10: time taken until the torque reached 10% of the maximum torque on 150° C./6 minute curing.
t80: time taken until the torque reached 80% of the maximum torque on 150° C./6 minute curing.

Separately, each of compositions V, VI and VII was placed in a rectangular frame of 2 mm deep, deaerated again, press cured at 100 kgf/cm² and 150° C. for 10 minutes, and post cured at 200° C. for 4 hours. From the cured sample, a specimen was cut out and measured for physical properties according to JIS K-6251 and 6253. The results are shown in Table 9.

TABLE 9
Rubber physical properties

| | Comparative | | | |
|---|---|---|---|---|
| | Example 1 | Example 2 | | |
| | Composition | Composition | Composition | Composition |
| | I | V | VI | VII |
| Hardness | 40 | 40 | 41 | 42 |
| (Durometer | | | | |
| type A) | | | | |
| Elongation, % | 540 | 520 | 500 | 470 |
| Tensile | 10.7 | 10.6 | 10.5 | 10.6 |
| strength, MPa | | | | |

There have been described curable fluoropolyether base rubber compositions which cure at an adjustable curing rate into products having solvent resistance, chemical resistance, parting property, water repellency and acid resistance owing to a high fluorine content. The cured products are useful in a variety of applications requiring oil resistance, for example, as rubber materials for automobiles and aircraft, seal materials for semiconductor manufacturing apparatus, tent film materials, sealants, molded parts, extruded parts, coatings, roll materials for copiers, moisture-proof coatings for electric apparatus, potting materials for sensors, and release paper materials.

Japanese Patent Application No. 2000-390456 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A curable fluoropolyether base rubber composition comprising
(A) a linear fluoropolyether compound containing at least two alkenyl groups in a molecule and having a perfluoropolyether structure in its backbone,
(B) an organosilicon compound having at least two hydrogen atoms each bound to a silicon atom in a molecule, all the silicon atom-bound hydrogen atoms forming H—Si(R)₂OSi structures wherein R is independently a monovalent hydrocarbon group having 1 to 6 carbon atoms,
(C) an organosilicon compound having at least two hydrogen atoms each bound to a silicon atom in a molecule, all the silicon atom-bound hydrogen atoms forming H—SiR(OSi)₂ structures wherein R is a monovalent hydrocarbon group having 1 to 6 carbon atoms,
(D) a hydrosilylation catalyst, and
(E) an acetylenic hydrosilylation inhibitor.

2. The composition of claim 1 wherein the linear fluoropolyether compound (A) has the following general formula (1): 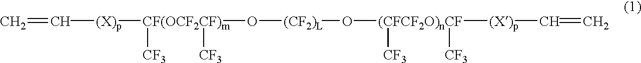
wherein X is —CH₂—, —CH₂O— or —Y—NR′—CO— wherein Y is —CH₂—or a group of the following structural formula (Z): 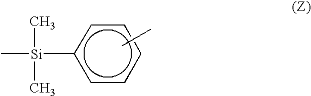
X′ is —CH₂—, —OCH₂— or —CO—NR′—Y′— wherein Y′ is —CH₂— or a group of the following structural formula (Z′): 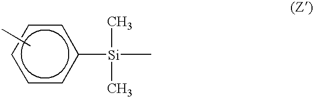
and R′ is hydrogen, methyl, phenyl or allyl, p is independently equal to 0 or 1, L is an integer of 2 to 6, m and n each are an integer of 0 to 200.

3. The composition of claim 1 wherein the organosilicon compound (B) has the following general formula (2), (3) or (4): 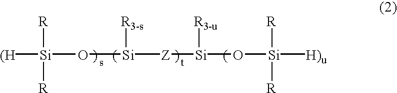
wherein R is independently a monovalent hydrocarbon group having 1 to 6 carbon atoms, Z is a divalent hydrocarbon group which may contain an ether bond or in which some or all of the hydrogen atoms may be substituted with fluorine, s and u each are 1, 2 or 3, and t is 0 or 1, with the proviso that s=1 when t=0, 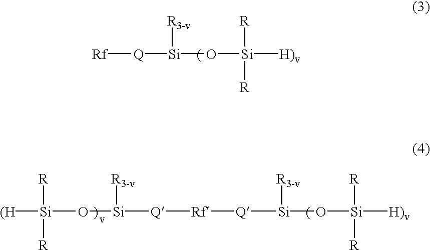
wherein R is as defined above, Q is a divalent hydrocarbon group of 1 to 12 carbon atoms which may contain an ether bond, Rf is a monovalent perfluoroalkyl or perfluorooxyalkyl group, Q′ is a divalent organic group, Rf′ is a divalent perfluoroalkylene or perfluorooxyalkylene group, and v is 1, 2 or 3.
